(19) United States
(12) Patent Application Publication
(10) Pub. No.: US 2014/0260788 A1
(43) Pub. Date: Sep. 18, 2014

(54) GEARBOX DEVICE WITH COOLED DRY-SUMP AREA

(71) Applicant: Schaeffler Technologies AG & Co. KG, Herzogenaurach (DE)

(72) Inventor: Tomas Smetana, Herzogenaurach (DE)

(73) Assignee: Schaeffler Technologies GmbH & Co. KG, Herzogenaurach (DE)

(21) Appl. No.: 14/349,695

(22) PCT Filed: Oct. 5, 2011
(86) PCT No.: PCT/EP2011/067389

§ 371 Date: Apr. 4, 2014

(51) Int. Cl. F16H 57/04

(52) U.S. Cl. CPC F16H 57/0412
USPC 74/606 A

(57) ABSTRACT

The invention addresses the objective of providing a gearbox device with an actively cooled oil sump area. For this purpose a gearbox device is disclosed, including: a gearbox section 7, the gearbox section 7 being designed as a power-transmitting device; a gearbox housing section 13, said gearbox section 7 being arranged in a gearbox interior 16 of the gearbox housing section 13 and cooled and/or lubricated in the gearbox housing section 13 by a gearbox oil, and an oil sump area 11 for receiving the gearbox oil from the gearbox housing section 13, the oil sump area 11 being cooled by at least one cooling channel 19, the gearbox device having a partition wall 20 between the oil sump area 11 and the gearbox interior 16 so that these form two separate chambers, and including a passage area 21 connecting the two separate chambers fluidically to one another, so that the oil sump area 11 is constructed as a dry-sump area.

### BACKGROUND

The invention relates to a gearbox device with a gearbox section, wherein the gearbox section is formed as a power transferring device, with a gearbox housing section, wherein the gearbox section is arranged in a gearbox interior of the gearbox housing section, and wherein the gearbox section is lubricated and/or cooled in the gearbox housing section by gearbox oil, and with an oil sump area for holding the gearbox oil from the gearbox housing section, wherein the oil sump area is cooled by means of at least one cooling channel. The invention also relates to an electromotive gearbox device for providing a drive torque for a vehicle with the gearbox device.

Gearbox devices are used for transferring torque from a motor to a driven part. In the gearbox devices, the drive torque is typically increased, decreased, normalized, disconnected, or switched through. Due to the interacting parts in gearbox devices, friction is generated that leads to heating of the gearbox device. This heat can be discharged, on one hand, through passive measures, for example, a heat exchange between a housing surface of the gearbox device and the ambient air. Alternatively it is also possible to use an active cooling system and to control the temperature of the gearbox device, for example, by a coolant.

Thus, for example, the publication U.S. Pat. No. 6,432,018 B1 that forms the closest prior art, proposes for cooling channels to be integrated in a housing wall of a gearbox in the area of a wet sump and for a cooling medium, for example, water, to flow through these channels.

### SUMMARY

The invention is based on the objective of providing a gearbox device with an actively cooled oil sump area that represents an improvement of the prior art. Another objective of the invention is to disclose an electromotive gearbox device for a vehicle with this gearbox device. These objectives are met by a gearbox device and by an electromotive gearbox device. Preferred or advantageous embodiments of the invention are given in the dependent claims, the following description, and also the enclosed figures.

Thus, in the scope of the invention, a gearbox device is provided that is suitable and/or formed in an especially preferred way for a vehicle. In particular, the gearbox device is part of the drive train of the vehicle and is used for providing a drive torque for the vehicle.

The gearbox device comprises at least one gearbox section, wherein the gearbox section is formed as a power-transfer device. The power-transfer device is used for converting a torque, for example, as a drive torque for the vehicle. In the most general case, the conversion of the drive torque can involve an increase, reduction, distribution, combination, and/or switching of torques. The power-transfer unit can be formed, in particular, as a gearbox, in particular as a manual gearbox, automatic gearbox, overriding gearbox, and/or as a clutch. The gearbox section or the power-transfer device can also be only one partial section of a larger gearbox system.

The gearbox section is arranged in a gearbox interior of a gearbox housing section. The gearbox housing section can be formed, for example, as an aluminum casting section. In the gearbox interior, the gearbox section is lubricated and/or cooled by a gearbox oil. In particular, it is provided that the gearbox oil is fed to the gearbox section, lubricates or cools this section, and can be discharged from this section again. To hold the gearbox oil or to collect it from the gearbox housing section, the gearbox device has an oil sump area, wherein the oil sump area is cooled by at least one cooling channel. The at least one cooling channel carries, for example, a coolant, in particular, cooling water, for cooling the oil sump area. Thus, heat generated through friction and loading in the area of the gearbox section can be brought into the oil sump area via the gearbox oil and discharged from there by the at least one cooling channel. The at least one cooling channel can have, e.g., a zig-zag profile or a meander-shaped profile, wherein partial sections of the at least one cooling channel are arranged one next to the other or parallel to each other. Alternatively or additionally, a plurality of cooling channels can be provided.

In the scope of the invention it is proposed that the gearbox device has a partition wall between the oil sump area and the gearbox interior, so that these form two separate chambers, wherein the partition wall has a passage area that connects the two separate chambers to each other in terms of flow, but only such that the oil sump area is formed as a dry sump area.

The partition wall can be a straight or curved section with constant wall thickness. For alternative embodiments, the partition wall is freely shaped and/or can optionally also comprise additional functional components.

The invention is based on the idea that the use of a dry sump instead of a wet sump can significantly improve the operational capability of the gearbox device, especially for strong dynamic loads of the gearbox device. If the gearbox device is installed, for example, in a vehicle, then due to centrifugal forces when driving around curves it can occur that the gearbox oil is displaced in a wet sump area so far that the oil circuit is interrupted or at least disturbed. In contrast, through the dry sump it is guaranteed that even for the case of high centrifugal forces, the oil circuit remains secured. Additional advantages result from the fact that a wet sump area remains functional only if this is arranged on the bottom side during operation, so that the gearbox oil can run into the wet sump area due to gravity and also remains there. In contrast, the dry sump area has the advantage that the gearbox oil is collected in the dry sump and remains in the dry sump area—even for a temporary displacement from the bottom area—so that the functionality of the oil circuit is always guaranteed.

In terms of structure, the dry sump area therefore can be implemented such that the passage area has a correspondingly small, open diameter or opening area. For example, an open diameter of less than 4 cm², preferably less than 3 cm², and in particular less than 2 cm² appears to be practical.

In one preferred, structural construction of the invention, the oil sump area is formed by an oil sump housing section, wherein the cooling channels are arranged in the oil sump housing section. Therefore, because the gearbox section is arranged in the gearbox housing section and the oil sump is arranged in the oil sump housing section, the two housing sections can be designed independently from each other in terms of loading. Thus, for example, the gearbox housing section has a mechanically more stable design, because this must also carry loads of bearings for the gearbox section. In contrast, the oil sump housing section has a purely oil guiding function and therefore can have a relatively narrow, filigree, or thin design.

In particular, the partition wall forms an integral part of the gearbox housing section and stabilizes this section. In an especially preferred way, the wall thickness of the partition wall is formed like the boundary area of the gearbox housing section.

In one especially preferred embodiment of the invention, the cooling channels are arranged on a free side, outer side, or outer wall of the oil sump housing section. In particular, the cooling channels are not positioned between the oil sump and gearbox interior, because this would lead to a mechanical weakening of the partition wall and thus of the gearbox housing section. By separating the functions, (I) mechanical holding of the gearbox section and (II) guiding and cooling the gearbox oil, the two housing section can be designed for their respective functions without interfering dependencies.

In one preferred improvement of the invention it is provided that ribs, in particular, cooling ribs, are arranged on the oil sump housing section. The ribs or cooling ribs further improve the heat dissipation from the gearbox oil.

It is especially preferred that the oil sump housing section is formed as a separate part or separate assembly to the gearbox housing section. In this construction, it is possible for the housing comprising the oil sump housing section and the gearbox housing section to have only limited structural complexity. In particular, it is possible to form both the cooling channels and also the ribs in the separate oil sump housing section. In one refinement of the invention, the gearbox housing section and oil sump housing section are made from different materials. This is possible due to the separation of functions already described above.

In one alternative embodiment of the invention, the oil sump housing section and the gearbox housing section are formed as a common part, in particular, in one piece and/or from one material. In this embodiment, the complexity of this assembly is indeed unequally higher than for the previously described embodiment, but it eliminates an assembly step, which can reduce the production costs, especially in the case of high part numbers.

Another object of the invention is an electromotive gearbox device for providing a drive torque for a vehicle. The drive torque can be a main torque, so that the electromotive gearbox device drives the vehicle without additional motors. It can also be a partial torque, wherein the vehicle is driven by multiple motors. It can also be an auxiliary torque, wherein the drive torque is superimposed on a main drive torque of a different motor. The electromotive gearbox device is formed, in particular, as an electric axle for driving one or two wheels or part of a hybrid gearbox. The vehicle is formed, in particular, as a passenger car, truck, bus, etc.

The electromotive gearbox device comprises an electric motor that generates the drive torque. For the purpose of the definition it is set that the electric motor defines, in particular with its rotor shaft, an axial direction and a radial direction.

Furthermore, the electromotive gearbox device comprises the gearbox device according to one of the preceding claims or as was previously described for transferring the drive torque, wherein the gearbox section is arranged offset in an axial direction, advantageously adjacent to or bordering the electric motor in a second axial section.

The oil sump area is located, in an especially preferred way, at least in some section in the second axial section, so that this overlaps with the gearbox section in the radial direction.

In an especially preferred way, the oil sump area extends in the axial direction also into the first axial section of the electric motor, so that the oil sump area overlaps with the electric motor in the radial direction.

The extension of the oil sump area in an otherwise advantageously gearbox oil-free partial area of the electromotive gearbox device has the advantage that both the volume and also the outer surface area of the oil sump area is increased. By increasing the volume, simultaneously the oil reservoir and thus the total quantity of the gearbox oil in the electromotive gearbox device is increased, so that the lubricating and/or cooling function can be implemented by a larger quantity of gearbox oil. Furthermore, a plenum chamber is formed for the gearbox oil, so that, for example, bubbles or foam can be removed.

Enlarging the surface, in particular, the outer surface of the oil sump area, leads to an increase in the cooling surface for the gearbox oil, so that the cooling of the electromotive gearbox device is improved.

Thus, the extension of the oil sump area in the axial direction into the first axial section by the increase of the volume and the outer surface leads to improved operational behavior of the electromotive gearbox device.

Simultaneously, the oil sump area does not have to have a thick construction in the radial direction despite the increased volume or the increased surface area, so that clearance of the electromotive gearbox device from the ground in the installation position is not reduced.

In one possible, actual construction of the invention, the oil sump area extends in the axial direction over at least 50%, advantageously at least 70%, and in particular over at least 90% of the length of the electric motor in the first axial section. The length of the electric motor in the axial direction is advantageously defined by the length of the stator of the electric motor. In this actual construction, it is thus claimed that the oil sump area projects not only on the edge side into the first section, but also utilizes the majority of the axially available installation space underneath the electric motor.

In one possible refinement of the invention, the oil sump area extends in a projection or top view into the first section over at least 50%, preferably over at least 70%, and in particular over at least 90% of the width of the electric motor in the first axial section.

If looking at the projection surface from above, alternatively or additionally it can also be claimed that at least 50%, preferably at least 70%, and in particular at least 90% of the projection surface of the electric motor is covered by the oil sump area.

These refinements are also used to form the oil sump area in a compact way and simultaneously with a large volume and/or a large surface area.

In one especially preferred embodiment of the invention, the oil sump area is formed in the first and/or second section as a flat channel. Looking at a cross section perpendicular to the axial direction, the oil sump area has a larger extent in the horizontal direction than in the vertical direction in its installation position.

In one actual construction of the invention, the electromotive gearbox device is formed as an electric axle for the vehicle, which has at least one driven shaft, advantageously two driven shafts for transferring the drive torque to one or two wheels of the vehicle. The electric motor is advantageously arranged coaxial to the at least one driven shaft.

### BRIEF DESCRIPTION OF THE DRAWINGS

Additional features, advantages, and effects of the invention are given from the following description of preferred embodiments of the invention. Shown herein are:

FIG. 1 a schematic top view of a vehicle with an electromotive gearbox device as a first embodiment of the invention, and

FIG. 2 a schematic section view through the electromotive gearbox device in the area of the electric motor.

### DETAILED DESCRIPTION OF THE PREFERRED EMBODIMENTS

In a top view from the front and greatly schematized, FIG. 1 shows a vehicle 1 in the area of its axles 2 that can be formed as a front-wheel axle or rear-wheel axle. The axle 2 comprises an electromotive gearbox device 3 that is connected by two driven shafts 4a, b to wheels 5a, b, so that the electromotive gearbox device 3 drives the wheels 5a, b.

The electromotive gearbox device 3 is used in this embodiment of the invention for generating the main drive torque for the vehicle 1. For this purpose, the electromotive gearbox device 3 comprises an electric motor 6 and a gearbox section 7 for converting the drive torque from the electric motor 6. The electric motor 6 has, for example, a power greater than 30 kW, preferably greater than 50 kW, and in particular greater than 70 kW. Thus the electromotive gearbox device 3 is formed as an electric axle, so that the electric motor 6 provides, as a drive torque, a main drive torque for moving the vehicle 1 forward. For the applied embodiments, the electromotive gearbox device can also be formed, e.g., as a hybrid gearbox, wherein another drive torque of a different motor, for example, an internal combustion engine, is superimposed on the drive torque of an electric motor 6, so that the main drive torque for the wheels 5a, b is formed by the motors together or alternately.

With its rotor shaft (not shown), the electric motor 6 defines a rotational axis 8 that forms a reference parameter for an axial direction and a radial direction for the electromotive gearbox device 3.

The electric motor 6, in particular, the rotor and the stator of the electric motor 6, is arranged coaxial to the rotational axis 8. The driven shafts 4a, b are also positioned coaxial to the rotational axis 8. The driven shaft 4a on the side of the electric motor 6 can be formed, for example, as a plug-in axle that is passed through a hollow shaft in the electric motor 6, wherein the hollow shaft is formed to transfer the drive torque from the electric motor 6 into the gearbox section 7.

The gearbox section 7 is formed as a geared gearbox, for example, as a two-gear gearbox that converts the drive torque 6 and also transfers it to the two driven shafts 4a, b—in the sense of a differential function. In an especially preferred way, the gearbox section 7 is formed as a planetary gearbox with spur gears.

The electromotive gearbox device 3 thus has, considered in the axial direction relative to the rotational axis 8, a first axial section 9 in which the electric motor 6 is arranged and a second axial section 10 in which the gearbox section 7 is arranged. The axial sections 9, 10 are adjacent to each other, wherein, however, the electric motor 6 and gearbox section 7 are separated from each other by at least one partition wall.

While the electric motor 6 is continuously lubricated, for example, by a grease lubricant, the gearbox section 7 is both lubricated and also cooled by gearbox oil. The gearbox oil is located in an oil circuit, wherein, considered in terms of flow, the gearbox oil from the gearbox section 7 is collected in an oil sump 11 arranged at the bottom side on the electromotive gearbox device.

The housing of the electromotive gearbox device 3 is divided into an electric motor housing section 12, a gearbox housing section 13, and an oil sump housing section 14. The electric motor housing section 12 defines an interior 15 in which the electric motor 6 is arranged; the gearbox housing section 13 defines an interior 16 in which the gearbox section 7 is arranged, and the oil sump gearbox section 14 defines an interior 17 that forms the oil sump 11.

The electric motor housing section 12 and the gearbox housing section 13 together form the shape of a straight hollow cylinder with an outer diameter D. The oil sump housing section 14 is placed on the bottom side in this shape outside of the diameter D.

The oil sump 11 or the interior 17 is thus connected in terms of flow to the interior 16 of the gearbox housing section 13. In contrast, the interior 17 or the oil sump 11 is isolated in terms of flow from the interior 15 of the electric motor housing section 12.

As produced from FIG. 1, in this embodiment, the axial extent of the oil sump 11 is not limited to the axial extent of the gearbox housing section 13, but instead extends in the axial direction underneath the electric motor housing section 12 into the first axial section 9. More precisely, the oil sump housing section 14 is closed on its two end sides in the axial direction, that is, on both sides, flush with the electric motor housing section 12 or gearbox housing section 13. Thus, the oil sump 11 extends in the axial direction over 90% in the first axial area 9.

Due to the axial extension of the oil sump area 11 or the oil sump gearbox housing section 12, the oil reservoir for the gearbox oil is significantly increased. On one hand, an expanded plenum chamber is thus formed for the gearbox oil. On the other hand, a cooling surface for the oil sump 11 to the ambient air is likewise increased. The increase of the oil reservoir is here realized without very large restriction to the ground clearance, that is, the clear distance between the bottom side of the motor housing section 14 and the ground 18.

According to the embodiment of the invention, however, it can also be sufficient to limit the oil sump 11 on the second axial section 10.

FIG. 2 shows a section view of the electromotive gearbox device 3 in the area of the gearbox section 7 perpendicular to the rotational axis 8. From this representation it can be seen that the gearbox housing section 13 and the oil sump housing section 14 are formed in one piece from a common material. In the shown sectional view, the oil sump 11 or the interior 17 has the shape of a flat channel, wherein the top side of the flat channel has a curved shape and is matched to the curvature of the interior 16, so that a partition wall 20 with a constant thickness is produced between the oil sump 11 or interior 17 and the interior 16. In contrast, the bottom side of the oil sump 11 or the interior 17 is flat or planar. At the side, the oil sump 11 or the interior 17 is limited by walls that have constant thickness and are oriented parallel to the outer side. Overall the maximum extent of the flat channel in the horizontal direction h is greater than the maximum extent in the vertical direction v.

The oil sump 11 is formed as a dry sump, wherein gearbox oil from the interior 16 reaches into the oil sump 11 through a passage opening 21. The passage opening 21 has a narrow shape and assumes less than 20% of the bottom surface area of the interior 16 and/or the surface area of the oil sump 11 in the second axial section 10. This embodiment has the advantage that oil supply fluctuations cannot be produced even if the electromotive gearbox device 3 is subjected to strong centrifugal forces.

Furthermore, the partition wall 20 can be designed so that this is designed for the mechanical requirements for the gearbox section 7. In particular, the wall thickness is equal to the wall thickness in the area of the top of the gearbox housing section 13.

In the bottom area of the oil sump housing section 14 there are cooling channels 19 that extend in the axial direction parallel to the rotational axis 8. In an especially economical way, the cooling channels 19 can be formed in a shaping method in the oil sump housing section 14. A coolant, in particular, a cooling water, is led through the cooling channels 19. This coolant cools the gearbox oil in the oil sump 11. The cooling channels 19 are in a bottom side outer wall of the oil sump housing section 14. Optionally, the cooling channels 19 extend over the entire axial length of the oil sump 11.

In FIG. 1, optional additional ribs 22 are provided on the oil sump housing section 14, wherein these ribs extend parallel to the ground 18 and in the direction of travel and produce additional air cooling of the oil sump 11. In particular, it is shown that the ribs 22 are made from individual ribs that are arranged spaced apart from each other in the axial direction and extend in the direction of the ground 18.

The cooling channels 19 can extend over the first and the second axial section 9, 10—similar to the ribs 22.

### LIST OF REFERENCE NUMBERS

1 Vehicle
2 Axle
3 Electromotive gearbox device
4a, b Drive shafts
5a, b Wheels
6 Electric motor
7 Gearbox section
8 Rotational axis
9 First axial section
10 Second axial section
11 Oil sump
12 Electric motor housing section
13 Gearbox housing section
14 Oil sump housing section
15 Interior of the electric motor housing section
16 Interior of the gearbox housing section
17 Interior of the oil sump housing section
18 Ground
19 Cooling channels
20 Partition wall
21 Passage opening
22 Rib

1. A gearbox device comprising a gearbox section, formed as a power transfer device, a gearbox housing section having a gearbox interior in which the gearbox section is arranged, wherein the gearbox section is at least one of lubricated or cooled in the gearbox housing section by a gearbox oil, an oil sump area for holding gearbox oil from the gearbox housing section, the oil sump area is cooled by at least one cooling channel, a partition wall located between the oil sump area and the gearbox interior, the oil sump area and the gearbox interior form two separate chambers, and a passage area connects the two separate chambers to each other with respect to a flow of fluid, so that the oil sump area is formed as a dry sump area.

2. The gearbox device according to claim 1, wherein the oil sump area is formed by an oil sump housing section, and the cooling channels are arranged in the oil sump housing section.

3. The gearbox device according to claim 2, wherein the cooling channels are arranged on a free side of the oil sump housing section.

4. The gearbox device according to claim 3, wherein ribs are arranged on the oil sump housing section.

5. The gearbox device according to claim 2, wherein the oil sump housing section is formed as a separate part to the gearbox housing section.

6. The gearbox device according to claim 2, wherein the oil sump housing section and the gearbox housing section are formed as a common part.

7. An electromotive gearbox device for providing a drive torque for a vehicle, comprising an electric motor for generating the drive torque, the electric motor defines an axial direction and a radial direction and the electric motor is arranged in a first axial section, and the gearbox device according to claim 1, for transferring the drive torque arranged in a second axial section offset in the axial direction relative to the electric motor.

8. The electromotive gearbox device according to claim 7, wherein the oil sump area extends in the axial direction into the first axial section of the electric motor.

9. The electromotive gearbox device according to claim 7, wherein the oil sump area is formed in the first axial section as a flat channel.

10. The electromotive gearbox device according to claim 7, wherein the gearbox device is formed as an electric axle that has at least one driven shaft for transferring the drive torque to a wheel of the vehicle, and the electric motor is arranged coaxial to the at least one driven shaft and the oil sump area extends into a bottom area of the first section.
